(19) United States
(12) Patent Application Publication
(10) Pub. No.: US 2026/0307582 A1
(43) Pub. Date: Oct. 8, 2026

(54) VEHICLE-TO-VEHICLE LIGHTING SYNCHRONIZATION

(71) Applicant: WHELEN ENGINEERING COMPANY, INC., Chester, CT (US)

(72) Inventor: Griffin David Shepherd, Old Saybrook, CT (US)

(73) Assignee: WHELEN ENGINEERING COMPANY, INC., Chester, CT (US)

(21) Appl. No.: 19/638,545

(22) Filed: Apr. 3, 2026

Related U.S. Application Data
(60) Provisional application No. 63/784,177, filed on Apr. 6, 2025.

(51) Int. Cl. B60Q 1/26; G01S 1/68; G01S 19/10; H05B 47/155; H05B 47/175; H05B 47/19

(52) U.S. Cl. CPC B60Q 1/2611; G01S 1/68; G01S 19/10; H05B 47/155; H05B 47/19; H05B 47/1985; B60Q 2900/30; B60Q 2900/50

(57) ABSTRACT

A synchronization module receives timestamp information and a pulse-per-second (PPS) signal via a GNSS receiver, and the synchronization module transmits a synchronization signal to multiple, independent lightheads without relying on a central system. Each of the lightheads may synchronize one or more lighting elements based on the synchronization signal. The lightheads may be associated with one or more emergency vehicles.

### CROSS-REFERENCE TO RELATED APPLICATION(S)

This application is related to and claims the benefit of priority from U.S. Provisional Application No. 63/784,177, titled “LOCAL VEHICLE-TO-VEHICLE LIGHTING SYNCHRONIZATION,” filed on Apr. 6, 2025, the full disclosure of which is hereby incorporated by reference in its entirety for all purposes.

### BACKGROUND

### 1. Field of Disclosure

Embodiments of disclosure relates to systems and methods for locally synchronizing lighting systems between one or more vehicles.

### 2. Description of Related Art

In many vehicles, lightheads (e.g., lighting apparatuses such as those used on emergency vehicles) benefit from synchronization, as do lightheads present across multiple vehicles. Synchronization provides for coordinated lighting at an emergency scene, and when the lights of different vehicles are flashing in a synchronized manner the output is less distracting to drivers and non-emergency personnel in the area. This creates a safer environment for emergency personnel and non-emergency personnel in the area. Synchronization can also be used to strategically coordinate warning lights across vehicles, for example, based on vehicle tasks at an emergency scene. However, synchronization systems often require a central controller in each vehicle as a part of a complex control system. Such systems can be both physically cumbersome, difficult to install, and expensive.

### SUMMARY

Example embodiments may provide a system for synchronizing one or more independent lightheads. The system may include a synchronization apparatus further including an antenna to receive one or more satellite signals comprising one or more timestamp data and pulse-per-second (PPS) data. The system may further include a global navigation satellite system (GNSS) transceiver coupled to the antenna, the GNSS transceiver to extract the timestamp data and PPS data from the received satellite signals. The system may further include a microcontroller coupled to the GNSS transceiver. The microcontroller may receive the timestamp data and PPS data from the GNSS transceiver. The microcontroller may also generate, based at least on the timestamp data and PPS data, a synchronization signal, and transmit the synchronization signal. The system may further include a synchronization circuitry coupled to the microcontroller, the synchronization circuitry to receive the synchronization signal and transmit the synchronization signal to one or more independent lightheads each comprising one or more lighting elements, wherein the synchronization signal is to synchronize the one or more lighting elements on the one or more independent lightheads. In some example embodiments, the independent lightheads may correspond to one or more emergency vehicles. Furthermore, the synchronization signal may synchronize one or more light color patterns of the one or more lighting elements. The synchronization signal may further synchronize a rotation speed or flash rate of the one or more independent lightheads. Each of the lighting elements within a lighthead may use multiple colors of light. As a nonlimiting example, the one or more lighting elements may include a first color, second color, and third color. In some example embodiments, the microcontroller may store one or more historical timestamp data in a data storage unit, and the synchronization circuitry may transmit the synchronization signal over a wired or wireless connection to the one or more independent lightheads. In other example embodiments, the synchronization apparatus may be removably attached to a first vehicle, and the one or more independent lightheads may correspond to one or more second vehicles. In still other embodiments, the synchronization apparatus may be removably attached a first vehicle, and the one or more independent lightheads may correspond to the first vehicle. Furthermore, the synchronization apparatus may be removably attached to a power source in a first vehicle.

Example embodiments may further provide for a method including receiving, by a local synchronization module from a global positioning system (GPS) satellite, one or more satellite signals comprising one or more timestamp data and pulse-per-second (PPS) data. The method may further include extracting the timestamp data and PPS data from the one or more satellite signals and generating, based at least on the timestamp data and PPS data, a synchronization signal. The method may further include transmitting the synchronization signal to one or more independent lightheads each comprising one or more lighting elements, wherein the synchronization signal is to synchronize the one or more lighting elements on the one or more independent lightheads. In some example embodiments, the method may further include transmitting the synchronization signal upon detecting the one or more independent lightheads on a wireless network and adjusting the synchronization signal to control a color output of the one or more independent lightheads. In still other example embodiments, the method may further include adjusting the synchronization signal to synchronize at least one of a flash rate, rotation speed, or strobe pattern of the one or more independent lightheads and storing the one or more timestamp data in a data storage unit.

Example embodiments may further provide a processor which may transmit a synchronization signal to one or more independent lightheads each comprising one or more lighting elements, wherein the synchronization signal is to synchronize the one or more lighting elements on the one or more independent lightheads, wherein the synchronization signal is generated based at least on one or more timestamp data and one or more pulse-per-second (PPS) data received from a global-positioning-system (GPS) satellite. In some example embodiments, the synchronization signal may synchronize one or more light color patterns of the one or more lighting elements. The synchronization signal may further synchronize a rotation speed or flash rate of the one or more lighting elements. In still other example embodiments, the processor may also transmit the synchronization signal upon detecting the one or more independent lightheads on a wireless network and store the one or more timestamp data in a data storage unit.

### BRIEF DESCRIPTION OF THE DRAWINGS

Various embodiments in accordance with the present disclosure will be described with reference to the drawings, in which:

FIG. 1 illustrates a system for synchronizing lightheads according to example embodiments;

FIG. 2A illustrates a vehicle with a synchronization module according to example embodiments;

FIG. 2B illustrates a synchronization module for synchronizing lightheads on multiple vehicles according to example embodiments;

FIG. 3A illustrates a system for synchronizing lightheads according to example embodiments;

FIG. 3B illustrates a system for synchronizing lightheads according to example embodiments;

FIG. 4 illustrates a process for synchronizing lightheads according to example embodiments; and

FIG. 5 illustrates a system for executing a synchronization module according to example embodiments.

### DETAILED DESCRIPTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose. Additionally, like reference numerals may be used for like components, but such use should not be interpreted as limiting the disclosure.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. Moreover, references to “substantially” or “approximately” or “about” may refer to differences within ranges of +/−10 percent. Furthermore, like numbers may be used to refer to like elements throughout, but it should be appreciated that using like numbers is for convenience and clarity and not intended to limit embodiments of the present disclosure. For example, one or more subsequent figures may share similar features with one or more prior figures and the similar features may be identified with like reference numerals for convenience purposes only and not to limit the scope of the present disclosure.

This disclosure is directed to systems and methods for synchronizing standalone lightheads and lighting apparatuses by interfacing directly with a local implementation of a synchronization mechanism and without relying on a central system. A synchronization module may connect with the local synchronization processors of one or more separate, standalone lightheads. The lightheads may be connected to a single vehicle or distributed across multiple vehicles. When multiple vehicles will have synchronized lightheads, each of the vehicles may include one or more of their own synchronization modules. Each synchronization module may receive a timestamp from a global positioning system (GPS) via a GPS receiver, or from a global navigation satellite system (GNSS) antenna and a pulse per second (PPS) signal via a GNSS receiver. Each synchronization module may connect with one or more lightheads via a circuit interface. On a single vehicle with multiple lightheads, upon initialization, the synchronization module would listen or scan for pulses already being generated by the independent lightheads and sent over a wired or wireless connection. Then, the synchronization module would interface, over a wired or wireless connection, with the local synchronization systems in each lighthead to synchronize the light emitting from the lightheads. In other embodiments, the synchronization module may also synchronize other elements of the lightheads or other components on the vehicle, such as an audio output of a siren or speaker.

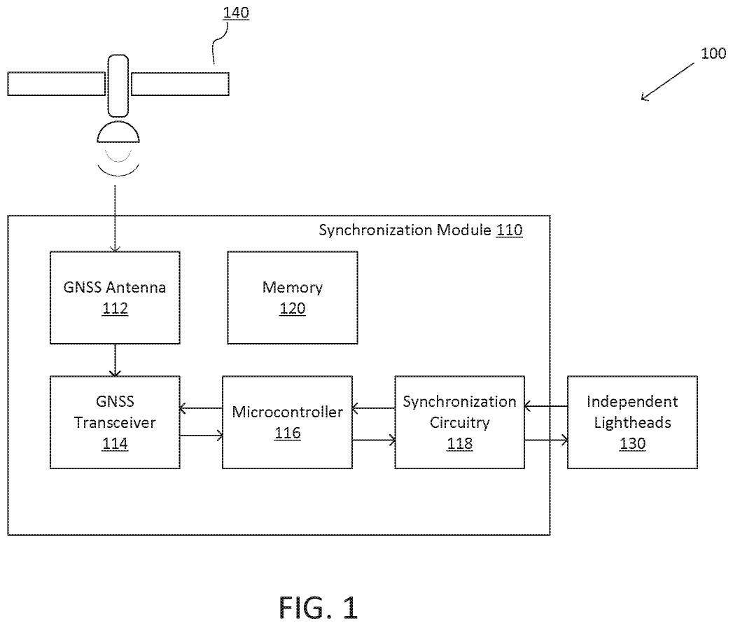

FIG. 1 illustrates a system 100 for synchronizing independent lightheads 130 across one or more vehicles. A synchronization module 110 may be included in each vehicle having lightheads to be synchronized. The synchronization modules may synchronize the timing of one or more lighting elements, lightbars, or other lighting components that include one or more of the independent lightheads 130 without relying on some central or integrated system. For example, an emergency vehicle may include a lightbar having a plurality of lightheads therein. The lightheads may, for example, be provided so as to direct light outwards from the lightbar in a 360 degree field of view, and may contain lightheads along the front and back of the lightbar as well as the sides of the lightbar. In other embodiments, the lightheads may be integrated separately (i.e., not in a single lightbar) into the body of the vehicle (e.g., as a headlight or taillight) or mounted on the vehicle (e.g., on the hood, roof, or trunk). The synchronization module 110 may synchronize the independent lightheads 130 by interfacing directly with the independent lightheads 130 themselves. Although FIG. 1 illustrates only a certain number of elements, it is understood that other elements or combinations of elements may be used to produce the desired results as discussed herein.

The synchronization module 110 may include an antenna 112, GNSS transceiver 114, microcontroller 116, synchronization circuitry 118, and a memory 120. The synchronization module 110 may carry out (i.e., perform, execute, and the like) various functions. As used in the present disclosure, the synchronization module includes both hardware and instructions. The hardware can include one or more processors, one or more microprocessors, one or more microcontrollers, one or more microchips, one or more application-specific integrated circuits (ASICs), one or more field programmable gate arrays (FPGAs), one or more graphical processing units (GPUs), one or more tensor processing units (TPUs), and/or one or more devices and/or components of any other type deemed suitable by those of skill in the art for a given implementation. In some cases, a module includes at least one functional component (e.g., an application or part of an application, a block of code, and/or the like) executing in whole or in part on one or more processors of a host system or device.

The instructions for a given module are executable by the hardware for carrying out the one or more herein-described functions of the module, and can include hardware (e.g., hardwired) instructions, firmware, software, and/or the like, stored in any one or more non-transitory computer-readable media deemed suitable by those of skill in the art for a given implementation. Each such computer-readable medium can be or include memory (e.g., random access memory (RAM), read-only memory (ROM), erasable programmable read-only memory (EPROM), electrically erasable programmable read-only memory (EEPROM a.k.a. EPROM), flash memory, and/or one or more other types of memory) and/or one or more other types of non-transitory computer-readable medium. A module can be realized as a single component or be distributed across multiple components as deemed suitable by those of skill in the art.

The antenna 112 may receive one or more signals including timing information from a global positioning satellite 140 such as a GPS satellite, GNSS satellite, or any other suitable or equivalent satellite system. Generally, the antenna 112 may capture signals or radio waves transmitted by the global positioning satellite 140 (and other satellite constellations) and send the signals to the GNSS transceiver 114 and/or the microcontroller 116. In example embodiments, the antenna 112 may collect the satellite signals and pass them (i.e., transmit them) to the GNSS transceiver 114, at which point the GNSS transceiver 114 may be extract various time information from the signal such as, without limitation, timestamp data and pulse-per-second (PPS) data. The timestamp data may include a data value representing a specific moment in time, and it may be measured in some predetermined metric such as milliseconds relative to a reference point such as unix time or coordinate universal time (UTC). As a nonlimiting example, the timestamp data may include an exact time such as “12:34:56.789 UTC.” In some example embodiments, the PPS signal may be derived from the timestamp and represent the start of each second or other unit of time relative to the timestamp data. The PPS signal may be received every second or predetermined unit of time. The antenna 112 may transmit this time information over a connection (e.g., without limitation, a connection bus, coaxial cable, radio frequency cable, or printed circuit board trace) to the GNSS transceiver 114, to which the antenna 112 is mounted via a printed circuit board, and the GNSS transceiver 114 may output the timestamp information and the PPS signal to the microcontroller 116.

The microcontroller 116 may receive the information from the GNSS transceiver 114, including at least the timestamp data and the PPS signal over a wired or wireless communication link or connection. The microcontroller 116 may receive the timestamp data and PPS signal from the GNSS transceiver 114 and process this information. In some example embodiments, the microcontroller 116 may interpret the timestamp data to determine the exact time reference to be used with the PPS signal. In some example embodiments, the microcontroller 116 may format, adjust, preprocess, or edit the timestamp data and PPS signal to generate a synchronization signal that is compatible with the synchronization circuitry 118. Based on this processing timing information (i.e., the timestamp data and PPS signal), the microcontroller 116 may transmit a command or synchronization pulse to the synchronization circuitry 118. This command or pulse may instruct the synchronization circuitry to transmit signals to the independent lightheads 130 to, e.g., trigger their lighting elements according to a given timestamp or pulse information.

The microcontroller 116 may include one or more processors of any type deemed suitable by those of skill in the relevant art, some examples including a general-purpose microprocessor and a dedicated digital signal processor (DSP). The microcontroller 116 can include one or more microprocessors, one or more microchips, one or more ASICs, one or more FPGAs, one or more GPUs, one or more TPUs, and/or one or more processing devices and/or processing components of any other type.

The synchronization circuitry 118 may include an electronic component within the synchronization module 110. In example embodiments, the synchronization circuitry 118 may include a printed circuit board (PCB) including one or more processors, amplifiers, and output components. The synchronization circuitry 118 may be designed to interface with the independent lightheads 130. The synchronization circuitry 118 may receive one or more pulse signals or processed time signals from the microcontroller 116. In some example embodiments, the synchronization circuitry 118 may further process (e.g., amplify) the signal to ensure a reliable transmission to the independent lightheads 130. In example embodiments, upon initialization, the synchronization circuitry 118 may receive pulse signals from the independent lightheads 130 to determine information about the independent lightheads 130 or lamps that are connected to the synchronization module. This can include, for example, the number and type of lightheads, and the number and type of other lighting components. To do this, the synchronization module may listen for and measure the pulse signals generated by the lightheads and lighting components. The synchronization circuitry 118 may then output one or more signals or pulses that match the required synchronization pattern for the independent lightheads 130 and lighting components, for example, a synchronization pulse that synchronizes the number of lightheads and lighting components. Finally, the synchronization circuitry 118 may transmit these signals via a wired or wireless connection (or both) to the independent lightheads 130.

In example embodiments, the synchronization circuitry 118 includes, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

The synchronization module 110 may also include a memory 120. The memory 120 may store one or more timestamps or pulse information. The memory 120 may take the form of any non-transitory computer-readable medium or combination of such media, some examples including flash memory, ROM, and RAM to name but a few, as any one or more types of non-transitory data-storage technology deemed suitable by those of skill in the relevant art can be used. In at least one embodiment, the memory 120 contains instructions that are executable by the memory 120 for carrying out various functions described herein as being carried out on or by the synchronization module 110 and/or the microcontroller 116. As described herein, in at least some example embodiments, the instructions include an application executable by the microcontroller 116 to carry out such functions.

Generally, the synchronization module 110 may be powered by an internal or external power source. In some example embodiments, the synchronization module 110 may be powered by a battery or other independent power storage unit. In other example embodiments, the synchronization module 110 may be connected to an external power source via one or more wired connections, e.g., to the battery of a vehicle.

In some example embodiments, the only requirement for the independent lightheads 130 to interface with the synchronization circuitry 118 is for the independent lightheads 130 to be configured to both transmit pulse signals regarding some information about the lighting elements (e.g., whether the lighting element has one color, two colors, or three colors) and to receive pulse signals from the synchronization circuitry 118. Thus, existing independent lightheads 130 do not need additional hardware or software modifications to interact with the synchronization circuitry 118. In other words, the synchronization circuitry 118 may interface with lightheads of different hardware configurations, for example, lightheads from the different generations of manufacture. As a nonlimiting example, the synchronization circuitry 118 may send pulse signals to various lightheads of different ages (e.g., lightheads manufactured 10-15 years ago as well as 2-5 years ago) and still successfully synchronize them, assuming that each lighthead is configured to transmit and receive the discussed pulse signals. Thus, the synchronization modules may be installed with existing lightheads and lighting components, in order to retrofit them to be able to implement synchronized lighting patterns. This would allow, for example, existing emergency vehicles to be retrofit so that flashing patterns from lighting devices thereon can be synchronized with each other, and with lighting devices on one or more other vehicles that also incorporate a synchronization module.

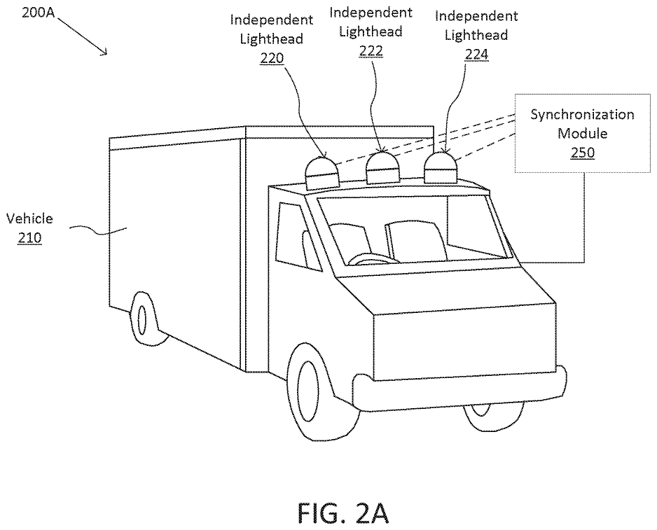

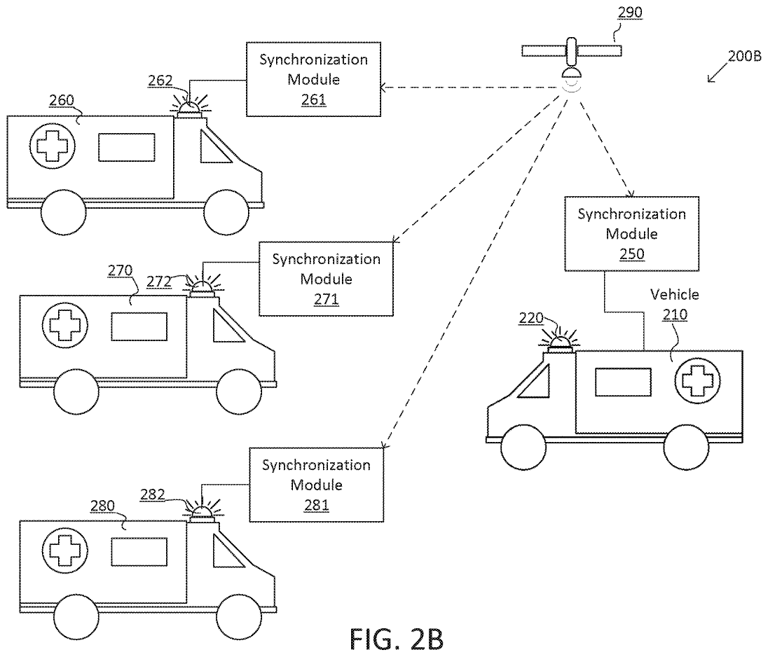

FIG. 2A illustrates a system 200A for synchronizing one or more independent lightheads 220, 222, and 224 on a vehicle 210. In example embodiments, a vehicle 210 (e.g., an emergency vehicle) may have one or more independent lightheads 220, 222, and 224 mounted on the body of the vehicle 210. Each of these independent lightheads 220, 222, and 224 may be separate from each other—that is, the lightheads are not connected to a central system or central controller. In example embodiments, the independent lightheads 220, 222, and 224 may each use an internally standardized method of synchronization. Where multiple lightheads are included in a lightbar, for example, one synchronization module may be included with the lightbar and all lightheads within the lightbar connected to the synchronization module. The synchronization module 250 may be mounted on any area suitable for making a wireless connection to with a GNSS signal. In example embodiments, the synchronization module 250 may be placed in the driver's cabin, on the roof of the driver's cabin proximate to the independent lightheads 220, 222, and 224, or any other suitable area. The synchronization module 250 may be connected to each of the independent lightheads 220, 222, and 224 by a wired or wireless connection. In other example embodiments, any single vehicle 210 may include multiple synchronization modules 250 which may connect to one or more of the independent lightheads 220, 222, and 224. For example, there may be a synchronization module dedicated to different groupings of lighting components, such as individual lightheads or lightbars incorporating multiple lightheads, at different areas of the vehicle. There may be a synchronization module for lightbars on the roof of the vehicle, and another synchronization module for lightheads and lighting devices at the rear of the vehicle.

The synchronization module 250, discussed with further reference to FIG. 1, may synchronize each of the independent lightheads 220, 222, and 224 by receiving timestamp and PPS information from a satellite signal or GNSS signal. Once this timestamp and PPS information is processed, the synchronization module 250 may interface with the independent lightheads 220, 222, and 224 to transmit a synchronization signal to each of the independent lightheads 220, 222, and 224. As a nonlimiting example, the synchronization module 250 may transit separate signals to each of the lightheads 220, 222, and 224. The synchronization module 250 may transmit each of these signals separately or at the same time.

In some example embodiments, the synchronization module 250 may establish a connection to each of the independent lightheads 220, 222, and 224. When the synchronization module 250 is installed in the vehicle 210, the synchronization module 250 may search or scan for one or more independent lightheads 220, 222, and 224. In example embodiments, each of the independent lightheads 220, 222, and 224 may connect to one another via a wired connection, and each lighthead may also connect to the synchronization module 250 through another wired connection. Upon turning on, the synchronization module 250 may determine an appropriate synchronization pulse to output to the independent lightheads 220, 222, and 224 based at least on the pulse already being output among and between the independent lightheads 220, 222, and 224. In an example embodiment, when the independent lightheads 220, 222, and 224 are turned on, they will each emit a pulse indicating, for example, how many colors are being emitted (e.g., each of the lighting elements within a lighthead may use multiple colors of light such as a solo, duo, or trio of colors). Once the synchronization module 250 has established a connection with the one more independent lightheads 220, 222, and 224, the synchronization module 250 may transmit a synchronization pulse or synchronization pulse signal to each of the independent lightheads 220, 222, and 224. This synchronization pulse or pulse signal may be based at least in part on the pulses received from each of the independent lightheads 220, 222, and 224, such as, for example, how many colors are being emitted. Each of the independent lightheads 220, 222, and 224 may receive these signals, and based on these signals, cause one or more lighting elements of each independent lighthead 220, 222, and 224 to synchronize with each other. In example embodiments, the lighting elements of each independent lighthead 220, 222, and 224 may emit light at the same time and in the same pattern or movement, including rotating about an axis (e.g., like a siren), strobing, and/or flashing according to the synchronized signal.

The synchronization module 250 may also receive one or more information from the independent lightheads 220, 222, and 224. Once the synchronization module 250 is connected to the one or more independent lightheads 220, 222, and 224, the independent lightheads 220, 222, and 224 may transmit signals indicative of one or more elements of each of the independent lightheads 220, 222, and 224. In example embodiments, the independent lightheads 220, 222, and 224 may transmit information such as the number of light elements within each lighthead (e.g., independent lightheads 220 has one color, whereas independent lightheads 222 and 224 have three colors each), the color of each of the light elements (e.g., independent lightheads 220 has one active color, whereas independent lightheads 220 and 224 have three active colors), or any other similar information about the independent lightheads 220, 222, and 224.

The independent lightheads 220, 222, and 224 may be included in, without limitation lamps, lightbars, headlights, and other similar lighting elements. In some example embodiments, the independent lightheads 220, 222, and 224 may have mechanical elements that cause the independent lightheads to move or rotate similar to a siren. In some example embodiments, once a lighthead has been synchronized by the synchronization module, the lighthead may maintain the timing of its lighting elements even if the synchronization module 250 goes out of range or if the synchronization module 250 loses the GNSS signal.

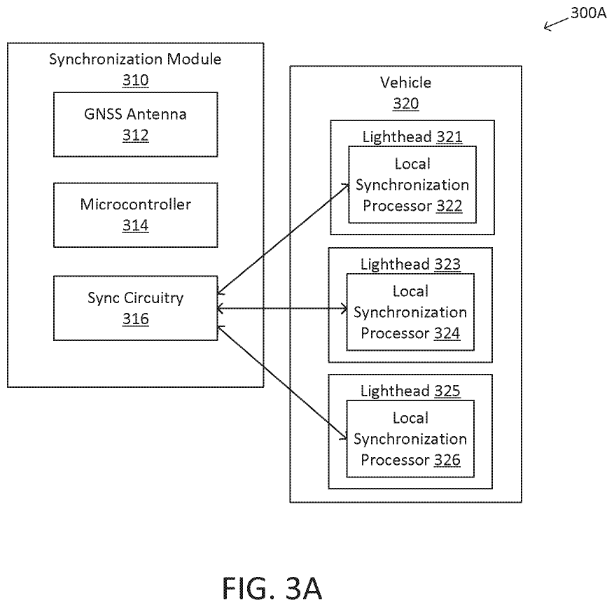

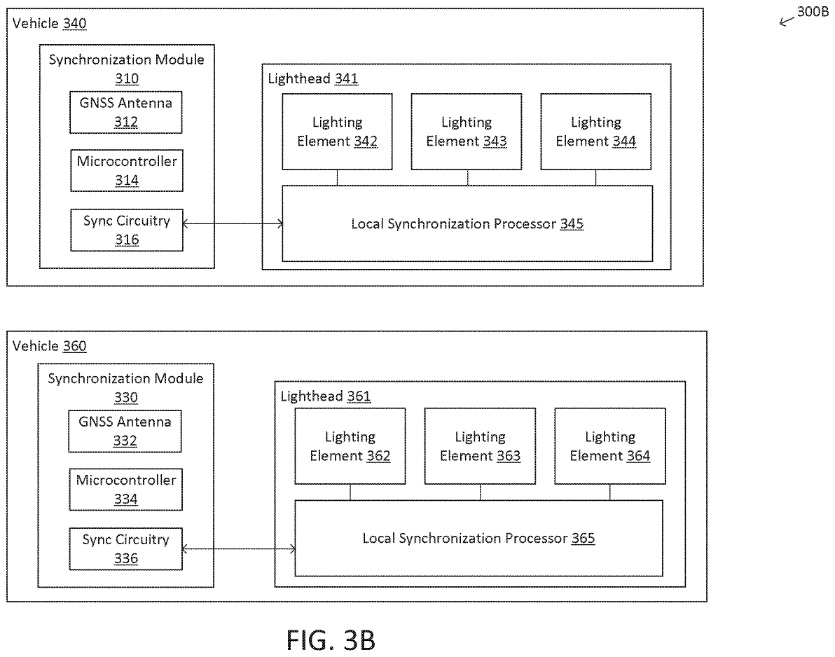

FIG. 2B illustrates a system 200B for synchronizing independent lightheads on multiple vehicles. In the system 200B, multiple vehicles 260, 270, and 280 may be outfitted with one or more independent lightheads 262, 272, and 282, respectively. In some example embodiments, the independent lightheads 262, 272, and 282 may be mounted on top of a driver's cabin or any other suitable area on the vehicles 260, 270, and 280. Furthermore, the vehicles 260, 270, and 280 may include synchronization module 261, synchronization module 271, and synchronization module 281, respectively, each of which perform the same functions as synchronization module 250. Although FIG. 2B illustrates only single lightheads on each vehicle 210, 260, 270, and 280, it is understood that each vehicle may be outfitted with multiple lightheads as discussed with further reference to FIG. 2A and FIG. 3B.

As discussed with further reference to FIG. 2A, the synchronization module 250 may transmit synchronization signals to synchronization module 261, synchronization module 271, and synchronization module 281. Each of the synchronization module 261, synchronization module 271, and synchronization module 281 may independently synchronize with a satellite 290 as discussed with further reference to the synchronization module 110 in FIG. 1. The process for synchronizing these lighting elements across multiple vehicles 260, 270, and 280 is functionally the same as synchronizing across lightheads on a single vehicle as discussed with further reference to FIG. 2A. That is, one or more of the synchronization modules, such as, e.g., synchronization module 250, may receive timestamp and PPS data from an antenna and GNSS transceiver receiving time data from the satellite 290. The synchronization module 250 may transmit a pulse signal to each of the synchronization module 261, synchronization module 271, and synchronization module 281, each of which may, in turn, operate their respective lightheads based on the received pulse information.

FIG. 3 illustrates a system 300A in which a synchronization module 310 transmits synchronization signals to a vehicle 320 with multiple lightheads 321, 323, and 325. The synchronization module 310 may include a GNSS antenna 312, microcontroller 314, and synchronization circuitry 316, each of which is discussed with further reference to FIG. 1. The vehicle 320 may include multiple lightheads mounted on or within the vehicle, such as lightheads 321, 323, and 325. The lightheads 321, 323, and 325 may include local synchronization processors 322, 324, and 326, respectively. Each of the local synchronization processors 322, 324, and 326 may include one or more processors of any type deemed suitable by those of skill in the relevant art, some examples including a general-purpose microprocessor and a dedicated digital signal processor (DSP). The synchronization circuitry 316 may transmit one or more synchronization signals over a wireless connection to the local synchronization processors 322, 324, and 326. The local synchronization processors 322, 324, and 326 may receive these signals and share them (e.g., over a wired connection bus) to one or more light emitting elements in each respective lighthead.

FIG. 3B illustrates a system 300B for synchronizing multiple lighting elements across lightheads on different vehicles, e.g., the vehicle 340 and the vehicle 360. The vehicle 340 may include a synchronization module 310 including a GNSS antenna 312, microcontroller 314, and synchronization circuitry 316. The vehicle 340 may also include a lighthead 341, which itself may include lighting elements 342, 343, and 344, as well as a local synchronization processor 345. Similarly, the vehicle 360 may include its own synchronization module 330 including a GNSS antenna 332, microcontroller 334, and synchronization circuitry 336. The vehicle 360 may also include a lighthead 361, which itself may include lighting elements 362, 363, and 364, as well as a local synchronization processor 365. Each of the synchronization module 310 and synchronization module 330 may independently synchronize with satellite and GNSS signals as discussed with further reference to the synchronization module 110 in FIG. 1.

The lighting elements 342-344 and 362-364 may include lamps, headlamps, strobes, or other lighting elements known in the art. The local synchronization processors 345 and 365 may have same functions described with reference to the local synchronization processors 322, 324, and 326. Each of the local synchronization processors 345 and 365 may receive the synchronization signals from the synchronization circuitries 316 and 336, respectively, to synchronize each of their respective lighting elements. That is, each of the lighting elements 342-344 within the lighthead 341 may be synchronized to each other via the synchronization signals from the synchronization circuitry 316, and likewise the lighting elements 362-364 within lighthead 361 may be synchronized to each other via the synchronization signals from the synchronization circuitry 336. Furthermore, the lighting elements 342-344 and 362-364 may be synchronized to each other via one or more synchronization pulses or synchronization signals received by the synchronization module 310 and the synchronization module 330.

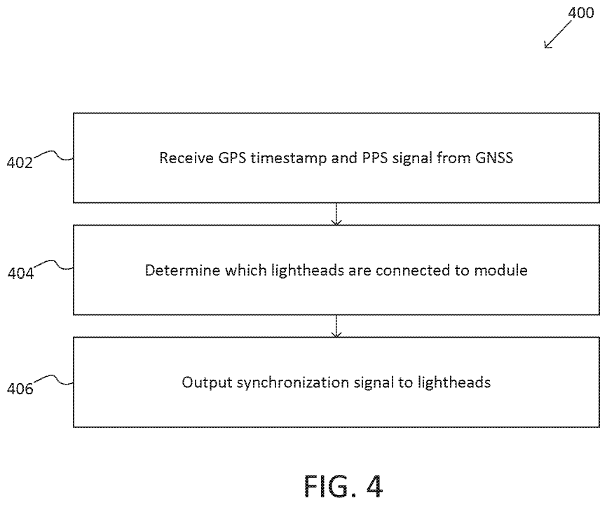

FIG. 4 illustrates a process 400 for synchronizing lighting elements across one or more independent lightheads according to systems and methods described elsewhere herein. The actions discussed in FIG. 4 may be performed by the synchronization module discussed with further reference to FIG. 1. The synchronization module may receive 402 timing information from a GPS satellite, such as timestamp and PPS information. The synchronization module may then determine 404 which local lightheads are connected to it (e.g., are connected to the synchronization circuitry in the synchronization module). The synchronization module may then output 406 a synchronization signal to one or more independent lightheads, including multiple independent lightheads on single vehicle, or multiple lightheads on several vehicles.

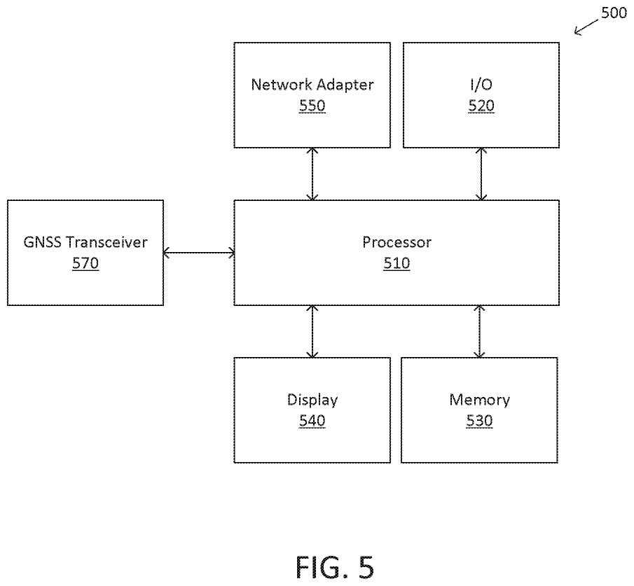

Referring to FIG. 5, the computing system 500 may include a processor 510, I/O devices 520, a memory 530, a display device 540, and/or a network adaptor 550. The processor 510 may drive the I/O devices 520, the memory system 530, the display device 540, and/or the network adaptor 550 through a bus. The computing system 500 may include a program module for performing the functions or operations described hereinabove with respect to at least one of the systems of FIGS. 1-4. For example, the program module may include routines, programs, objects, components, logic, data structures, or the like, for performing particular tasks or implementing particular abstract data types. The processor (e.g., 510) of the computing system 500 may execute instructions written in the program module to perform, e.g., the functions or operations described hereinabove with respect to at least one of the systems of FIGS. 1-4. The program module may be programmed into the integrated circuits of the processor (e.g., 510). In an example embodiment, the program module may be stored in the memory system (e.g., 530) or in a remote computer system storage media.

The computing system 500 may include a variety of computing system readable media. Such media may be any available media that is accessible by the computer system (e.g., 500), and it may include both volatile and non-volatile media, removable and non-removable media. The memory system (e.g., 530) can include computer system readable media in the form of volatile memory, such as RAM and/or cache memory or others. The computer system (e.g., 500) may further include other removable/non-removable, volatile/non-volatile computer system storage media.

The computer system (e.g., 500) may communicate with one or more devices using the network adapter (e.g., 550). The network adapter may support wired communications based on Internet, local area network (LAN), wide area network (WAN), or the like, or wireless communications based on code division multiple access (CDMA), global system for mobile communication (GSM), wideband CDMA, CDMA-2000, time division multiple access (TDMA), long term evolution (LTE), wireless LAN, Bluetooth, Zig Bee, or the like.

Various embodiments of the present disclosure may include a system, a method, and/or a non-transitory computer readable storage medium. The non-transitory computer readable storage medium (e.g., the memory system 530) has computer readable program instructions thereon for causing a processor to carry out aspects of the present disclosure.

The computer readable storage medium can be a tangible device that can retain and store instructions for use by an instruction execution device. The computer readable storage medium may be, for example, but not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EEPROM or Flash memory), a static random access memory (SRAM), a portable compact disc read-only memory (CD-ROM), a digital versatile disk (DVD), a memory stick, a floppy disk, or the like, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to the computing system 500 from the computer readable storage medium or to an external computer or external storage device via a network. The network may include copper transmission cables, optical transmission fibers, wireless transmission, routers, firewalls, switches, gateway computers and/or edge servers. A network adapter card (e.g., 550) or network interface in each computing/processing device receives computer readable program instructions from the network and forwards the computer readable program instructions for storage in a computer readable storage medium within the computing system.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the computing system (e.g., 500) through any type of network, including a LAN or a WAN, or the connection may be made to an external computer (for example, through the Internet using an Internet Service Provider). In an example embodiment, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

The computing system 500 may further include a GNSS transceiver 570 to receive timestamp and other time data continuously or periodically from a satellite such as a GPS satellite or GNSS satellite as described herein. The GNSS transceiver 570 may communicate this time data over a wired or wireless connection to the processor 510.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A system for synchronizing one or more independent lightheads, the system comprising a synchronization apparatus comprising:
an antenna to receive one or more satellite signals comprising one or more timestamp data and pulse-per-second (PPS) data;
a global navigation satellite system (GNSS) transceiver coupled to the antenna, the GNSS transceiver to extract the one or more timestamp data and PPS data from the one or more received satellite signals;
a microcontroller coupled to the GNSS transceiver, wherein the microcontroller:
receives the one or more timestamp data and PPS data from the GNSS transceiver; and
generates, based at least on the timestamp data and PPS data, a synchronization signal, and transmit the synchronization signal; and
a synchronization circuitry coupled to the microcontroller, the synchronization circuitry to receive the synchronization signal and transmit the synchronization signal to the one or more independent lightheads each comprising one or more lighting elements, wherein the synchronization signal synchronizes the one or more lighting elements on the one or more independent lightheads.

2. The system of claim 1, wherein the one or more independent lightheads correspond to one or more emergency vehicles.

3. The system of claim 1, wherein the synchronization signal synchronizes one or more light color patterns of the one or more lighting elements.

4. The system of claim 1, wherein the one or more lighting elements comprise a first color, a second color, and a third color.

5. The system of claim 1, wherein the synchronization signal further synchronizes a rotation speed or flash rate of the one or more independent lightheads.

6. The system of claim 1, wherein the microcontroller further stores one or more historical timestamp data in a data storage unit.

7. The system of claim 1, wherein the synchronization circuitry further transmits the synchronization signal over a wired or wireless connection to the one or more independent lightheads.

8. The system of claim 1, wherein the synchronization apparatus is removably attached to a first vehicle, and the one or more independent lightheads associated with one or more second vehicles.

9. The system of claim 1, wherein the synchronization apparatus is removably attached to a first vehicle, and the one or more independent lightheads associated with the first vehicle.

10. The system of claim 1, wherein the synchronization apparatus is removably attached to a power source in a first vehicle.

11. A method, comprising:
receiving, by a local synchronization module from a global positioning system (GPS) satellite, one or more satellite signals comprising one or more timestamp data and pulse-per-second (PPS) data;
extracting the one or more timestamp data and PPS data from the one or more satellite signals;
generating, based at least on the one or more timestamp data and PPS data, a synchronization signal; and
transmitting the synchronization signal to one or more independent lightheads each comprising one or more lighting elements, wherein the synchronization signal synchronizes the one or more lighting elements on the one or more independent lightheads.

12. The method of claim 11, further comprising:
transmitting the synchronization signal upon detecting the one or more independent lightheads on a wireless network.

13. The method of claim 11, further comprising:
adjusting the synchronization signal to control a color output of the one or more independent lightheads.

14. The method of claim 11, further comprising:
adjusting the synchronization signal to synchronize at least one of a flash rate, rotation speed, or strobe pattern of the one or more independent lightheads.

15. The method of claim 11, further comprising:
storing the one or more timestamp data in a data storage unit.

16. A processor to transmit a synchronization signal to one or more independent lightheads each comprising one or more lighting elements, wherein the synchronization signal synchronizes the one or more lighting elements on the one or more independent lightheads, wherein the synchronization signal is generated based at least on one or more timestamp data and pulse-per-second (PPS) data received from a global-positioning-system (GPS) satellite.

17. The processor of claim 16, wherein the synchronization signal synchronizes one or more light color patterns of the one or more lighting elements.

18. The processor of claim 16, wherein the synchronization signal further synchronizes a rotation speed or flash rate of the one or more lighting elements.

19. The processor of claim 16, wherein the processor further transmits the synchronization signal upon detecting the one or more independent lightheads on a wireless network.

20. The processor of claim 16, wherein the processor further stores the one or more timestamp data in a data storage unit.
